(19) United States
(12) Patent Application Publication
(10) Pub. No.: US 2026/0156058 A1
(43) Pub. Date: Jun. 4, 2026

(54) AGENT FOR MANAGEMENT AND PROCESSING OF PERFORMANCE MEASUREMENTS

(71) Applicant: Cisco Technology, Inc., San Jose, CA (US)

(72) Inventors: Frédérick Laflèche, Quebec (CA); Bernard Tremblay, Quebec (CA)

(21) Appl. No.: 18/907,758

(22) Filed: Oct. 7, 2024

(51) Int. Cl. H04L 43/08

(52) U.S. Cl. CPC H04L 43/08

(57) ABSTRACT

Techniques are provided for distributing performance measurement data to one or more delegating agents. A method includes one or more devices having connectivity to a network sending an identification and configuration request to one or more delegating agents to initiate a performance measurement session in the network, receiving session configuration data associated with the performance measurement session from the one or more delegating agents, and configuring the performance measurement session based on the session configuration data. The method further includes the one or more devices receiving performance measurement data from a reflector in the network during the performance measurement session and distributing the performance measurement data to the one or more delegating agents configured to manage or process the performance measurement data.

### TECHNICAL FIELD

The present disclosure relates to management and processing of performance measurements generated by small devices.

### BACKGROUND

Small devices, such as mobile phones, tablet computers, etc., are useful measurement points for generating network performance measurements. However, small devices often have limited processing capabilities and unreliable connectivity, and thus are not suitable for large-scale processing, computation or analysis of the generated performance measurements. Moreover, small devices are often protected by security systems such as firewalls. In a large network system with tens of thousands of devices generating network performance measurements, it is desirable to efficiently split the tasks of network performance measurement generation and network performance measurement data processing to avoid overloading the devices. Further, delegating the processing, computation and analysis of network performance measurements to dedicated resources ensures the consistency and accuracy of analytic results on the network performance measurement data.

### BRIEF DESCRIPTION OF THE DRAWINGS

FIG. 1 is a block diagram illustrating a system for splitting the generation and processing of network performance measurements, according to an example embodiment.

FIG. 2 is a block diagram illustrating an arrangement for managing communication between a device and a delegating agent, according to an example embodiment.

FIG. 3 is a block diagram illustrating an arrangement for establishing a network performance measurement generation session between a packet generator and a reflector, according to an example embodiment.

FIG. 4 is a block diagram illustrating a flow for processing, computation, and/or analysis of network performance measurement data, according to an example embodiment.

FIG. 5 is a diagram illustrating a graphical user interface displaying a performance measurement analytics dashboard, according to an example embodiment.

FIG. 6 is a sequence diagram for establishing a network performance measurement session, according to an example embodiment.

FIG. 7 is a flow chart illustrating a method for distributing network performance measurement data to one or more delegating agents, according to an example embodiment.

FIG. 8 is a flow chart illustrating a method for sending network performance measurement data to a sensor orchestrator or to a data analytics module, according to an example embodiment.

FIG. 9 is a hardware block diagram of a computing device configured to perform one or more techniques presented herein.

### DETAILED DESCRIPTION

### Overview

Techniques are provided for distributing network performance measurement data to one or more delegating agents. In one embodiment, a method includes one or more devices having connectivity to a network sending an identification and configuration request to one or more delegating agents to initiate a performance measurement session in the network, receiving session configuration data associated with the performance measurement session from the one or more delegating agents, and configuring the performance measurement session based on the session configuration data. The method further includes the one or more devices receiving performance measurement data from a reflector in the network during the performance measurement session and distributing the performance measurement data to the one or more delegating agents configured to manage or process the performance measurement data.

### Example Embodiments

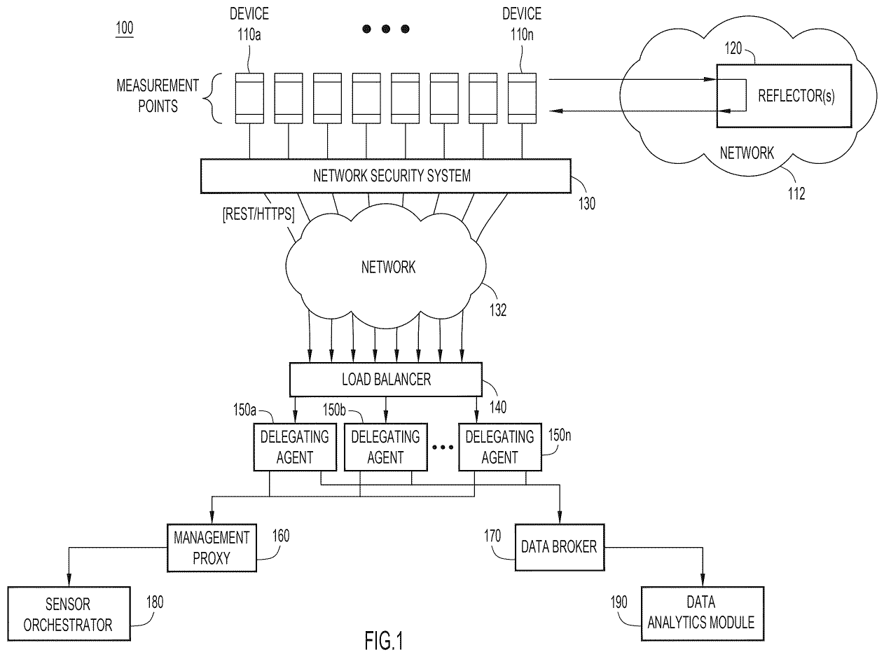

Reference is first made to FIG. 1, for a description of a block diagram illustrating a system 100 for splitting the generation and processing of network performance measurements, according to an example embodiment. The system 100 includes a plurality of devices 110a, . . . , 110n (also collectively denoted 110a-n), a network 112, one or more reflectors 120, a network security system 130, a network 132 a load balancer 140, a plurality of delegating agents 150a, 150b, . . . 150n (also collectively denoted 150a-n), a management proxy 160, a data broker 170, a sensor orchestrator 180, and a data analytics module 190. The notation “a-n” denotes that a number is not limited, can vary widely, and depends on a particular use case scenario.

The system 100 is configured to split the generation and processing of network performance measurements between the devices 110a-n and the delegating agents 150a-n. In the system 100, the devices 110a-n serve as network performance measurement points that interact with the one or more reflectors 120 in a performance measurement session in a network 112 to generate performance measurement data. The devices 110a-n may be small devices having limited processing capability such that they cannot manage or process the performance measurement data generated in the performance measurement session. For example, the devices 110a-n can be a mobile phone, a mobile computer, a router, a switch, a modem, or any other suitable devices. In certain embodiments, the one or more reflectors 120 may include remote devices that receive packets generated by applications on the devices 110a-n across the network 112. Based on the received packets, the one or more reflectors 120 generate and send response packets back to the devices 110a-n. The response packets contain data (e.g., timestamp information) that can be used to derive network performance measurements, such as a round trip time (RTT) measurement, packet loss, latency, delay, and jitter. The network 112 may include a local area network (LAN), a wide area network (WAN) such as the Internet, or a combination thereof, and includes wired, wireless, or fiber optic connections, with numerous network devices through which network traffic may travel. Further aspects associated with the performance measurement session between the devices 110a-n and the one or more reflectors 120 will be described below.

The devices 110a-n, having connectivity to the network 132, and may be protected by the network security system 130 associated with the network 132. The network 132 may include a local area network (LAN), a wide area network (WAN) such as the Internet, or a combination thereof, and includes wired, wireless, or fiber optic connections, with numerous network devices through which network traffic may travel. The network security system 130 may be implemented using hardware, software, or a combination thereof. For example, the network security system 130 may include a firewall that monitors and controls the flow of network traffic between the devices 110a-n and the load balancer 140 based on a set of security settings and/or rules. Further, the network security system 130 may utilize network address translation (NAT) and double-NAT technologies to provide added security to the devices 110a-n. In certain embodiments, the system 100 may be implemented using a Representational State Transfer (REST) architecture and/or Hypertext Transfer Protocol Secure (HTTPS). Utilizing a REST architecture allows for the implementation of cloud-based elastic deployments.

The network security system 130 controls the data, such as network performance measurement data, received by the load balancer 140 from the devices 110a-n. Once the load balancer 140 receives the performance measurement data, the load balancer 140 distributes the performance measurement data to the delegating agents 150a-n. The load balancer 140 evaluates the processing capability of each of the delegating agents 150a-n in view of the amount of network performance measurement data transmitted. Based on the evaluation, the load balancer 140 allocates the performance measurement data to one or more of the delegating agents 150a-n in an allocation scheme that would promote efficiency in processing time and/or other criteria (e.g., latency, resource utilization, etc.).

The load balancer 140 and the delegating agents 150a-n may be container-based microservice testing frameworks and/or software modules. In certain embodiments, the load balancer 140 and the delegating agents 150a-n may be implemented using an open-source container orchestration system such as Kubernetes®. Kubernetes is a registered trademark of the Cloud Native Computing Foundation. For example, the load balancer 140 and the delegating agents 150a-n may be implemented using Google Kubernetes Engine (GKE)®. Google Kubernetes Engine (GKE) is a registered trademark of Google LLC.

Each of the delegating agents 150a-n is configured to manage and/or process the performance measurement data received from the load balancer 140. In certain embodiments, the delegating agents 150a-n are configured to delegate the management of performance measurement data to the management proxy 160 and the processing of the performance measurement data to the data broker 170. In certain embodiments, the management proxy 160 and the data broker 170 may be implemented as process managers.

The management proxy 160 is configured to manage the network performance measurement data. For example, the management proxy 160 organizes and sends the network performance measurement data to the sensor orchestrator 180. The sensor orchestrator 180 may be a management platform where a user can view, monitor, and manage devices (e.g., sensors) in a network. The sensor orchestrator 180 updates and displays performance data associated with the devices in the network based on the network performance measurement data received from the management proxy 160.

The data broker 170 is configured to process the network performance measurement data to prepare the data for analysis by the data analytics module 190. For example, the data broker 170 is configured to perform preliminary processing, aggregation, and/or normalization of the performance measurement data to prepare the data for future use and analysis. The data broker 170 is configured to send the processed performance measurement data to the data analytics module 190 for further processing. Further aspects associated with the data broker 170 and data analytics module 190 will be described below.

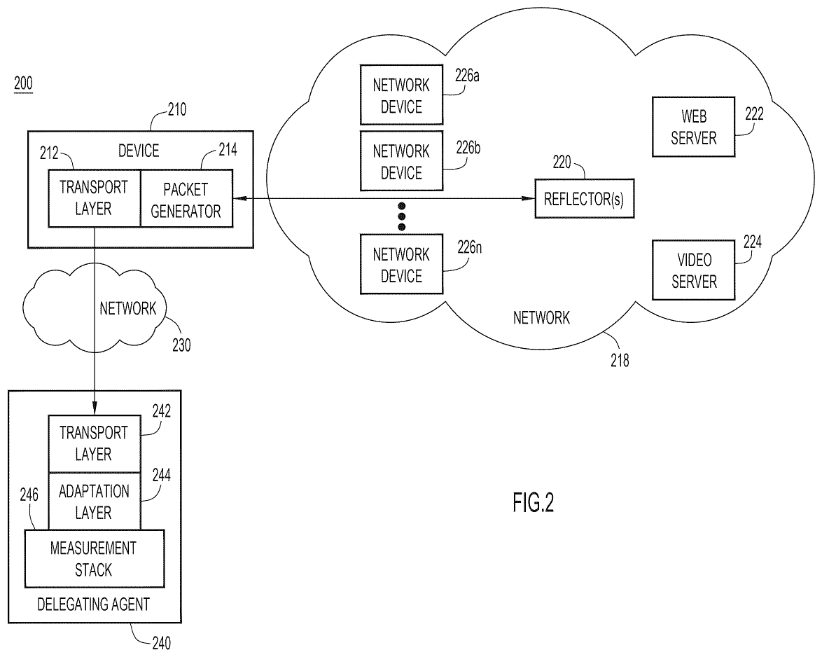

FIG. 2 is a block diagram illustrating an arrangement 200 for managing communication between a device and a delegating agent, according to an example embodiment. The arrangement 200 includes a device 210, one or more reflectors 220 which resides in a network 218 whose performance is to be measured, a network 230, and a delegating agent 240. The device 210 includes a transport layer 212 and a packet generator 214. The transport layer 212 is configured to communicate with a transport layer 242 of the delegating agent 240. The packet generator 214 is configured to interact with the one or more reflectors 220 to generate performance measurement data for the network 218. Further aspects associated with the interaction between the packet generator 214 and the one or more reflectors 220 will be described below.

The one or more reflectors 220 could be a dedicated hardware device or dedicated software, configured and designed to be capable of cooperating with the device 210 for making performance related measurements. The one or more reflectors 220 are deployed in each area/location or associated with each network entity for which it is desired to make network performance measurements. For example, one reflector may be deployed for a web server 222 and another reflector may be deployed for a video server 224. It is understood that multiple reflectors may be deployed for network entities in the network 218. The network 218 includes network devices 226a, 226b, . . . , 226n (also collectively denoted 226a-n) that impact the performance of the network 218. Examples of the network devices 226a-n include routers, gateways, switches, and any other suitable devices.

The delegating agent 240 includes the transport layer 242, an adaptation layer 244, and a measurement stack 246. The device 210 is configured to communicate with the delegating agent 240 via the network 230. More specifically, the transport layer 212 communicates with the transport layer 242 via the network 230. For example, the transport layer 212 is configured to transmit data packets containing network performance measurement data (representing performance of the network 218 where the one or more reflectors 220 resides) to the transport layer 242. The transport layer 212 and/or the transport layer 242 may utilize the Transmission Control Protocol (TCP) or User Datagram Protocol (UDP). The network 230 may include a local area network (LAN), a wide area network (WAN) such as the Internet, or a combination thereof, and includes wired, wireless, or fiber optic connections.

The adaptation layer 244 is configured to manage incoming network performance measurement data received by the transport layer 242. The measurement stack 246 is configured to delegate the performance measurement data to a sensor orchestrator and/or a data analytics module. In certain embodiments, the measurement stack 246 is configured to transmit the performance measurement data to the sensor orchestrator via a management proxy. In certain embodiments, the measurement stack 246 is configured to transmit the performance measurement data to a data broker to preprocess and prepare the data for analysis by the data analytics module.

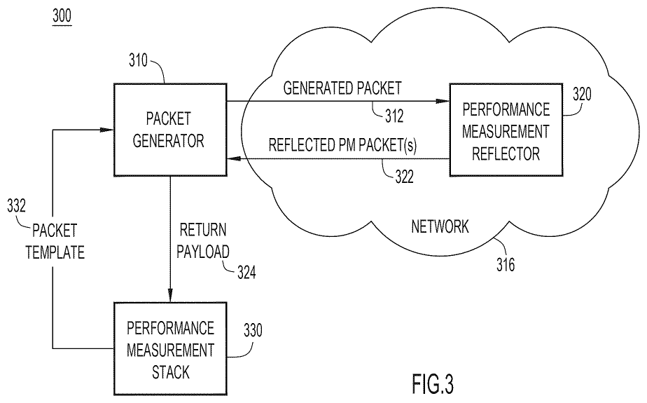

FIG. 3 is a block diagram illustrating an arrangement 300 for establishing a performance measurement generation session between a packet generator and a reflector, according to an example embodiment. The arrangement 300 involves a packet generator 310 (that typically resides on a device, such as one of the devices 110a-110n shown in FIG. 1 or device 210 shown in FIG. 2) configured to generate and transmit a generated packet 312 into network 316 to a performance measurement reflector 320. In certain embodiments, the packet generator 310 may be a software module configured to generate packets for a specific application to test application and/or network performance and/or functionalities in network. For example, the packet generator 310 may be implemented using a packet generator schema. An example packet generator schema is provided as follows:

```
{
  “$id”: “example.schema.json”,
  “$schema”: “https://json-schema.org/draft/2020-12/schema”,
  “title”: “Performance Metric Generator Template”,
  “type”: “object”,
  “properties”: {
    “packetGenerator”: {
      “protocol”: {
        “type”: “string”,
        “description”: “”,
        “enum”: [ “UDP”, “TCP” ]
      },
      “destinationPort”: {
        “type”: “integer”,
        “description”: “”
      },
      “destinationAddress”: {
        “type”: “string”
      },
      “packetTemplate”: {
        “type”: “array”,
        “items”: { #/$defs/packetSection” }
      }
    },
    “$defs”: {
      “packetSection”: {
        “type”: “object”,
        “properties”: {
          “name”: {
            “type”: “string”,
            “description”: “Name of packet section.”
          },
          “size”: {
            “type”: “integer”,
            “description”: “Size of section in bits.”
          },
          “type”: {
            “type”: “string”,
            “description”: “”,
            “enum”: [ “timestamp” ]
          },
          “clock”: {
            “type”: “string”,
            “description”: “”,
            “enum”: [ “MONOTONIC”,
            “MONOTONIC_RAW”, “REALTIME” ]
          },
          “timeFormat”: {
            “type”: “string”,
            “description”: “”,
            “enum”: [ “NTP”, “TAI”, “??” ]
          }
        }
      }
    }
}
```

The performance measurement reflector 320 may include a remote device deployed in network 316 and configured to receive the generated packet 312 from the packet generator 310 and generate a reflected performance measurement (PM) packet(s) 322 that will include test related information based on the data in the generated packet 312. Then, the performance measurement reflector 320 transmits the reflected PM packet(s) 322 back to the packet generator 310. The reflected PM packet(s) 322 may include data (e.g., timestamp information) associated with, or configured to derive, network metrics and/or application metrics. Examples of network metrics include RTT, packet loss, delay, jitter, latency, or any suitable metric indicative of network performance. Examples of application metrics include response time, error rate, central processing unit (CPU) usage, memory usage, or any suitable metrics indicative of application performance. The application for which the measurements are being derived resides in the network 316 in sufficient proximity to the performance measurement reflector 320.

After receiving the reflected PM packet(s) 322 from the performance measurement reflector 320, the packet generator 310 generates a return payload 324 containing the performance measurement related data from reflected PM packet(s) 322. Then, the packet generator 310 transmits the return payload 324 to a performance measurement stack 330. The performance measurement stack 330 may be located in a delegating agent, in accordance with various embodiments described herein. The performance measurement stack 330 is configured to transmit a packet template 332 to the packet generator 310. The packet template 332 includes information fields that indicate various parameters, such as clock type, timestamp format, packet size, etc. The packet generator 310 generates packets (e.g., generated packet 312) based on the packet template 332.

In certain embodiments, the performance measurement generation session between the packet generator 310 and the performance measurement reflector 320 may be a Two-Way Active Measurement Protocol (TWAMP) session. TWAMP sessions may be used to measure round-trip performance between the packet generator 310 and the performance measurement reflector 320. For example, metrics such as one-way delay and two-way delay can be determined in a TWAMP session. An example packet generator in a TWAMP session may be implemented as follows:

```
{
  “packetGenerator”: {
    “protocol”: “UDP”,
    “destinationPort”: 1234,
    “destinationAddress”: “ExampleAddress”,
    “captureReceiveTime”: true,
    “tupleHash”: “0x473947329587”,
    “ratePerSecond”: 1,
    “packetTemplate”: [
      {
        “name”: “Reflector Sequence Number”,
        “size”: 4,
        “type”: “fill”,
        “value”: 0
      },
      {
        “name”: “Reflector Transmission Time T3”,
        “size”: 8,
        “type”: “fill”,
        “value”: 0
      },
      {
        “name”: “Reflector Error Estimate”,
        “size”: 2,
        “type”: “fill”,
        “value”: 0
      },
      {
        “name”: “Reflector MBZ”,
        “size”: 2,
        “type”: “fill”,
        “value”: 0
      },
      {
          “name”: “Reflector Reception Time T2”,
        “size”: 8,
        “type”: “fill”,
        “value”: 0
      },
      {
        “name”: “Sender Sequence Number”,
        “size”: 4,
        “type”: “sequence”,
        “start”: “0xffff”,
        “step”: 1
      },
      {
        “name”: “Sender Transmission Time T1”,
        “size”: 8,
        “type”: “timestamp”,
        “clock”: “MONOTONIC_RAW”,
        “timeFormat”: “NTP”
      },
      {
        “name”: “Sender Error Estimate”,
        “size”: 2,
        “type”: “int”,
        “value”: 0
      },
      {
        “name”: “Sender MBZ”,
        “size”: 2,
        “type”: “fill”,
        “value”: 0
      },
      {
        “name”: “Sender TTL”,
        “size”: 1,
        “type”: “int”,
        “value”: 255
      },
      {
        “name”: “Packet Padding”,
        “size”: 55,
        “type”: “fill”,
        “value”: 0
      }
    }
  }
}
```

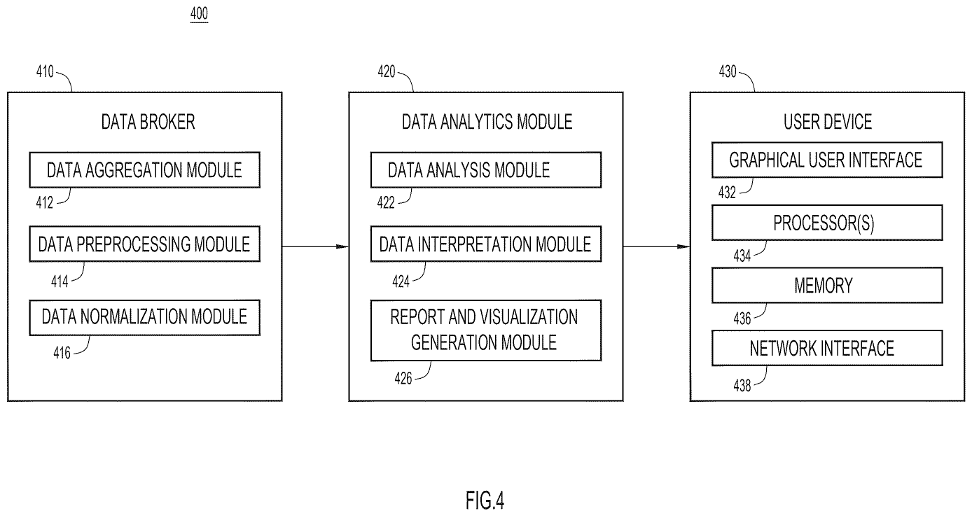

FIG. 4 is a block diagram illustrating a flow 400 for processing, computation, and/or analysis of performance measurement data, according to an example embodiment. The flow 400 involves a data broker 410, a data analytics module 420, and a user device 430. The data broker 410 and the data analytics module 420 are configured to generate insights on the performance measurement data received from one or more delegating agents and provide those insights to a user through the user device 430.

The data broker 410 includes a data aggregation module 412, a data preprocessing module 414, and a data normalization module 416. The data aggregation module 412 is configured to aggregate the performance measurement data received from the one or more delegating agents. In some embodiments, the data aggregation module 412 may aggregate performance measurement data transmitted during a predetermined reporting period before data analytics may be performed.

The data preprocessing module 414 is configured to perform preliminary processing on the performance measurement data to prepare the data for data mining and/or analytics. For example, the data preprocessing module 414 is configured to perform data cleaning, data integration, data transformation, and/or data reduction. More specifically, the data preprocessing module 414 may utilize data imputation techniques to fill in missing data and/or utilize dimensionality reduction, feature selection and extraction, and/or clustering techniques to capture meaningful data features suitable for data analytics. The data normalization module 416 is configured to convert the data to appropriate formats suitable for data mining and/or analytics. For example, the data normalization module 416 may use scaling and discretization to transform the performance measurements data.

Once the data broker 410 prepares the performance measurements data, the data broker 410 sends the prepared data to the data analytics module 420 for further processing. The data analytics module 420 includes a data analysis module 422, a data interpretation module 424, and a report and visualization generation module 426. The data analysis module 422 is configured to employ various techniques, such as artificial intelligence/machine learning and statistical analysis, to generate analytics results. Further, the data analysis module 422 is configured to generate forecasts, predictions, and/or estimations associated with network and/or application performance based on the network performance measurement data.

The data interpretation module 424 is configured to interpret the analytics results to derive insights and/or detect anomalies in a network. For example, the data interpretation module 424 may use explainable artificial intelligence (“explainable AI”) techniques to generate explanations and/or summaries associated with the analytics results. These explanations and/or summaries may be presented in a human-understandable format, such as reports written in natural language and/or including visual representations (e.g., charts, graphs, etc.). The report and visualization generation module 426 is configured to generate reports and/or visualizations of the analytics results produced by the data analysis module 422 and/or data interpretation module 424.

The user device 430 includes a graphical user interface 432, one or more processors 434, a memory 436, and a network interface 438. The memory 436 includes instructions for various software programs/modules to be executed by the one or more processors 434 to carry out certain aspects of the techniques presented herein. The graphical user interface 432 displays one or more reports and/or visualizations obtained from the data analytics module 420. Further, the graphical user interface 432 renders modifications to the displayed information based on input(s) received from a user and/or based on data received from the data analytics module 420. The network interface 438 enables communications between the user device 430 and other systems, entities, etc. to facilitate operations for various embodiments described herein.

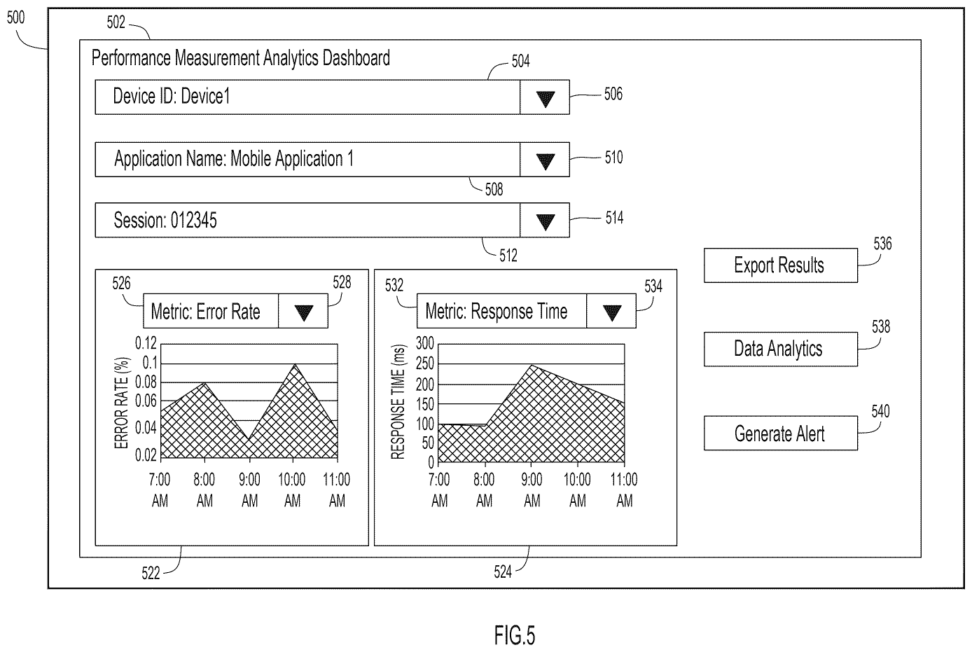

FIG. 5 is a diagram illustrating a graphical user interface displaying a performance measurement analytics dashboard, according to an example embodiment. The graphical user interface 500 of a user device displays network performance measurement analytics results generated by a data analytics module, in various embodiments described herein. For example, the graphical user interface 500 generates and displays a performance measurement analytics dashboard 502. The performance measurement analytics dashboard 502 includes a device selection facility 504 implemented as a drop-down box with a button 506, when clicked, provides a user with a list of network device identifiers (“IDs”) representing devices providing performance measurement data to a plurality of delegating agents in various embodiments described herein.

The performance measurement analytics dashboard 502 includes an application selection facility 508 implemented as a drop-down box with a button 510, when clicked, provides a user with a list of software applications being monitored on a particular device. Further, the performance measurement analytics dashboard 502 includes a session selection facility 512 implemented as a drop-down box with a button 514, when clicked, provides a user with a list of network performance measurement sessions associated with a corresponding device and/or application selected by the user.

The performance measurement analytics dashboard 502 displays reports and/or visualizations of analytics results associated with the network performance measurement session selected by the user. For example, a visualization element 522 provides a chart visualizing analytics results associated with a specific performance metric (e.g., error rate) for an application and/or a network (e.g., “Mobile Application 1” on “Device 1”) in a specific network performance measurement session. The visualization element 522 includes a metric selection facility 526 implemented as a drop-down box with a button 528, when clicked, provides a user with a list of performance metrics for which analytics results can be visualized. Further, another visualization element 524 provides a chart visualizing analytics results associated with a specific network performance metric (e.g., response time) associated with the selected application (e.g., “Mobile Application 1” on “Device 1”). The visualization element 524 includes a metric selection facility 532 implemented as a drop-down box with a button 534, when clicked, provides a user with another list of performance metrics for which analytics results can be visualized.

It should be understood that the visualization element 522 and the visualization element 524 can provide other forms of visualization and/or report, including but not limited to summaries, explanations, graphs, flow diagrams, etc. Further, in certain embodiments, additional visualization elements not illustrated in FIG. 5 may be added to the performance measurement analytics dashboard 502 based on user requirement.

The performance measurement analytics dashboard 502 further includes a button 536 for exporting analytics results and/or visualizations, a button 538 for generating additional data analytics, and a button 538 for generating alerts. After the user evaluates the visualizations displayed by the visualization element 522 and/or the visualization element 524, the user can export the analytics results and/or the visualizations to another source by clicking on the button 536. Moreover, the user may determine that additional data analytics of the performance measurement data are desired. The performance measurement analytics dashboard 502 displays additional options for data analytics in response to the user clicking on the button 538.

Further, the user can generate alerts through the button 540. For example, the user (e.g., system administrator) analyzes the visualizations displayed and determines anomalies in the data pattern that may involve attention from other users/entities. These anomalies in the data pattern may indicate a violation of service level agreement (SLA) in a network and/or degradation in quality of service (QoS) associated with an application or other service in a network. The alert option allows the user to promptly address potential issues associated with application and/or network performance by providing an intuitive tool to notify the appropriate parties. In certain embodiments, the user may set a threshold associated with a performance metric that automatically triggers an alert to be sent to an appropriate party. Thus, the techniques described herein provide users (e.g., service providers) an on-demand platform for monitoring customer SLAs and diagnosing network issues.

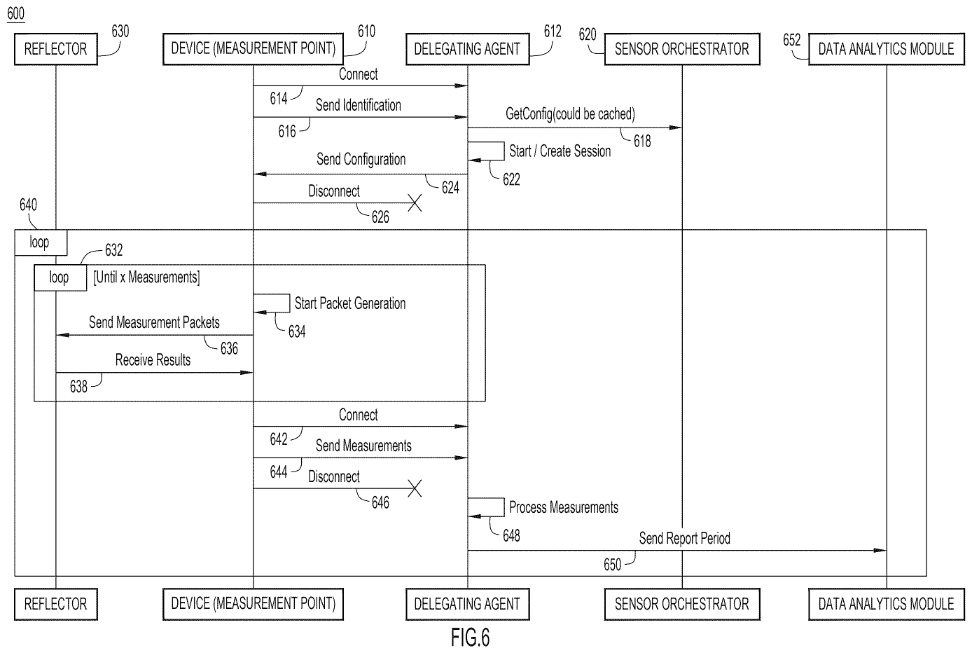

FIG. 6 is an operational sequence diagram 600 for establishing a network performance measurement session, according to an example embodiment. In the sequence diagram 600, a device 610, serving as a measurement point, initiates a connection with a delegating agent 612 at operation 614. In certain embodiments, the sequence diagram 600 may be implemented in the Skylight™ software platform (now Cisco® Provider Connectivity Assurance). Further, the device 610 may be a small device such as a mobile phone, a mobile computer, a router, a switch, a modem, or any other suitable devices.

In the performance measurement session, reflection may be performed by a reflector (e.g., remote device) and initiation/actuation of the session may be performed by a small device (e.g., the device 610). Alternatively, reflection may be performed by small devices and initiation/actuation may be performed by a reflector. However, because small devices are often protected by a network security system (e.g., behind firewall and multi-NATed), it would be undesirable to burden end users of small devices to open inbound ports (e.g., port forwarding) such that the small devices can perform reflection. Thus, in certain embodiments, the device 610 initiates a connection with the delegating agent 612 while a reflector 630 performs the reflection.

Once the device 610 initiates the connection with the delegating agent 612, the device 610 sends an identification and configuration request to the delegating agent 612 at operation 616. The identification and configuration request comprises information about the device 610 (e.g., device identifier), status of the device (e.g., whether device was updated), and a plurality of tags associated with the device 610. The identification and configuration request further comprises information about the performance measurement generation and analytics session, including a session identifier and information indicating whether the session is enabled. An example identification and configuration request is provided as follows:

```
# POST /skylight/agentGetConfig
{
  “deviceId”: “e24597d3-bc4e-4897-b6b4-5df00e369bc9”,
  “lastUpdate”: 0,
  “tags”: {
    “deviceName”: “my iPhone”,
    “geolocation”: “”,
    “wifiSSID”: “”
  },
  “sessions”: [
    {
      “sessionId”: “062da161-989a-4951-9aba-1c1c45649749”,
      “enable”: true
    }
  ]
}
```

The plurality of tags associated with the device 610 include various data that can be collected from the device. For example, the plurality of tags may include parameters such as data protocol (e.g., LTE, 3G, etc.), device signal strength, device name, device identifier, device manufacturer, device operating system (OS) version, device type (e.g., iPhone® or Android®), device version, geolocation, and/or measurement public Internet protocol (IP). The tags may further include parameters such as signal strength, service set identifier (SSID), and/or media access control (MAC) address of a wireless network using a specific protocol (e.g., Wi-Fi® wireless communication protocols). Data associated with tags such as data protocol, measurement public IP, Wi-Fi signal strength, and Wi-Fi SSID can change frequently. Further, Wi-Fi MAC address is a privacy feature that can change dynamically. iPhone is a registered trademark of Apple Inc. Android is a registered trademark of Google LLC.

After the delegating agent 612 receives the identification and configuration request from the device 610, the delegating agent 612 obtains a configuration of the network performance measurement session from a sensor orchestrator 620 at operation 618. In certain embodiments, the configuration may be cached. Then, the delegating agent 612 creates and/or starts the performance measurement session at operation 622 and sends session configuration data to the device 610 at operation 624. Example session configuration data may be as follows:

```
# Response: 200
{
  “deviceId”: “e24597d3-bc4e-4897-b6b4-5df00e369bc9”,
  “sessions”: [
    {
      “sessionId”: “062da161-989a-4951-9aba-1c1c45649749”,
      “enable”: true,
      “packetGenerator”: {
        “protocol”: “UDP”,
        “destinationPort”: 862,
        “destinationAddress”: “ExampleAddress”,
        “captureReceiveTime”: true,
        “ratePerSecond”: 1,
        “packetTemplate”: [
          {
            “name”: “Sender Sequence Number”,
            “size”: 4,
            “type”: “sequence”,
            “start”: 1,
            “step”: 1
          },
          {
            “name”: “Sender Transmission Time T1”,
            “size”: 8,
            “type”: “timestamp”,
            “clock”: “MONOTONIC_RAW”,
            “timeFormat”: “NTP”
          },
          {
            “name”: “Sender Error Estimate”,
            “size”: 2,
            “type”: “int”,
            “value”: “0x03ff”
          },
          {
            “name”: “Packet Padding”,
            “size”: 50,
            “type”: “fill”,
            “value”: 0
          }
        ]
      }
    }
  ]
}
```

After receiving the session configuration data from the delegating agent 612, the device 610 disconnects with the delegating agent 612 at operation 626. If a session represented by a session identifier is removed from the session configuration data, then the session is stopped.

Based on the session configuration data, the device 610 engages with the reflector 630 (e.g., remote device) to generate network performance measurement data, in accordance with embodiments described herein. At operation 634, the device 610 begins to generate measurement (test or probe) packets. Then, at operation 636, the device 610 sends the measurement packets to the reflector 630. Upon receiving the measurement packets, the reflector 630 generates and sends reflection results in the form of response packets back to the device 610. The response packets contain data (e.g., timestamp information) that can be used to derive network performance measurements, such as a RTT measurement, packet loss, latency, and jitter. At operation 638, the device 610 receives the reflection results. The operations 634, 636, and 638 proceed iteratively in a loop 632 until a threshold number of measurements has been reflected back to the device 610, thus ensuring that there are sufficient measurements to conduct robust analytics.

Once the device 610 receives the reflection results from the reflector 630, the device 610 connects with the delegating agent 612 at operation 642. Then the device 610 sends the reflected performance measurements to the delegating agent 612 at operation 644 and disconnects from the delegating agent 612 at operation 646. As the delegating agent 612 continuously receives reflected performance measurements from the device 610, the reflected performance measurements are updated. An example performance measurement data update is provided as follows:

```
# POST /skylight/agentUpdateData
{
  “deviceId”: “e24597d3-bc4e-4897-b6b4-5df00e369bc9”,
  “lastUpdate”: 909709709,
  “tags”: {
    “deviceName”: “my iPhone”,
    “geolocation”: “”,
    “wifiSSID”: “”,
    “wifiSignalStrength”: “”,
    “provider”: “”,
    “signalStrength”: “”
  },
  “sessions”: [
    {
      “sessionId”: “062da161-989a-4951-9aba-1c1c45649749”,
      “enable”: true,
      “measurements”: [
        {
          “receiveTime”: 9879879898798,
          “sequence”: “MAYBE”,
          “payload”: “BASE64”
        },
        {
          “receiveTime”: 9879879898798,
          “sequence”: “MAYBE”,
          “payload”: “BASE64”
        }
      ]
    }
  ]
}
```

Further, a “configChange” field indicates whether an updated configuration is available (e.g., “true” indicates available and “false” indicates not available). An example is provided as follows:

```
# Response 200
{
  “deviceId”: “e24597d3-bc4e-4897-b6b4-5df00e369bc9”,
  “configChange”: false
}
```

The delegating agent 612 processes the reflected performance measurements at operation 648. At operation 650, the delegating agent 612 sends a report period to a data analytics module 652. In certain embodiments, all reflected performance measurements received by the device 610 from the reflector 630 during the report period are analyzed by the data analytics module 652. The operations 642, 644, 646, 648, and 650, as well as the operations within the loop 632, proceed iteratively in a loop 640 until a predetermined stop condition is met. The predetermined stop condition may be associated with a number of iterations, a number of measurements collected, a length of time, or any suitable condition as determined by a user.

In one embodiment, the device 610 serves as a measurement point that holds session unique identifiers. Based on the session unique identifiers, a performance measurement session may be created automatically. When the device 610 connects with the delegating agent 612, a template is selected based on a grouping of data. The template may include tags such as geolocation and other metadata associated with the device 610. Session information is not stored in the sensor orchestrator 620 and all persistent data is kept on the device 610. The device 610 (measurement point) may have a specific session configuration, wherein the device 610 posts all measurements data for a reporting period to the sensor orchestrator 620 and/or the data analytics module 652 such that the measurements data are not preserved on the server or the delegating agent 612. Session continuity in the data analytics process enables grouping of data between connections. This embodiment is best suited for large deployments wherein one or more devices are located in a mass consumer market.

In another embodiment, the device 610 serves as a measurement point that holds session unique identifiers, but a performance measurement session is not created automatically based on the session unique identifiers. Instead, the performance measurement session is configured manually. Further, the performance measurement session and its data are stored in the sensor orchestrator 620. Stale data entries are removed using suitable data removal techniques.

In yet another embodiment, the device 610 serves as a measurement point that functions as an interface in the sequence diagram 600. In this embodiment, the sequence diagram 600 employs a system manager (e.g., a software module) to create a performance measurement session that uses the measurement point. Information associated with the measurement point is stored and/or presented to a user of the sequence diagram 600 in order to leverage the device 610 for performance measurement generation purposes. Further, the performance measurement session and its data are stored in the sensor orchestrator 620 and a configuration is stored for each individual measurement point. Stale data entries are removed using suitable data removal techniques.

In one example use case, a delegating agent 612 may be co-launched with a software application on the device 610. The delegating agent 612 leverages the sensor orchestrator 620 for test control and reporting of data associated with elements of a network. The device 610 is monitored and performance measurement data (e.g., packet delay or loss) as well as metadata (e.g., signal strength, network type, etc.) may be reported. The monitoring may be active only when the user is using the software application. Further, the monitoring may use low-bitrate performance measurement (e.g., at 1 packet per second (pps)). In other examples, tens of thousands of devices may be monitored at once, thus capturing a significant amount of performance measurement data. Further, in other example use cases, the delegating agent 612 may be implemented as a stand-alone software application that is not co-launched with the software application on the device 610.

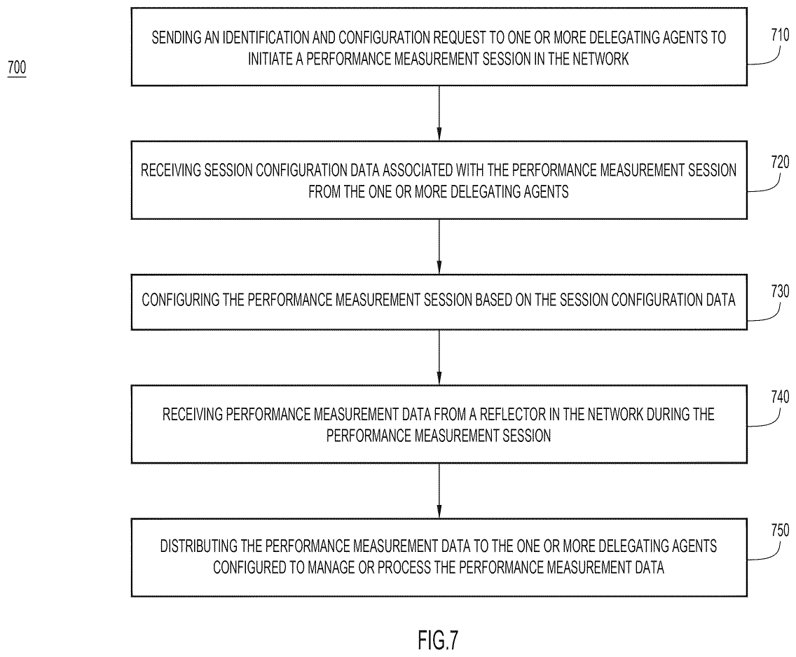

FIG. 7 is a flow diagram illustrating a method 700 for distributing network performance measurement data to one or more delegating agents, according to an example embodiment. The method 700 may be implemented by the devices 110a-n of FIG. 1.

At 710, the method 700 involves one or more devices having connectivity to a network sending an identification and configuration request to one or more delegating agents to initiate a performance measurement session in the network.

At 720, the method 700 involves the one or more devices receiving session configuration data associated with the performance measurement session from the one or more delegating agents.

At 730, the method 700 involves the one or more devices configuring the performance measurement session based on the session configuration data.

At 740, the method 700 involves the one or more devices receiving performance measurement data from a reflector in the network during the performance measurement session.

At 750, the method 700 involves the one or more devices distributing the performance measurement data to the one or more delegating agents configured to manage or process the performance measurement data.

In the method 700, the one or more devices comprise one or more of a mobile phone, a mobile computer, a router, a switch or a modem.

In the method 700, the identification and configuration request comprises one or more performance measurement parameters obtained from the one or more devices

In the method 700, the one or more performance measurement parameters comprise one or more of a data protocol, a data signal strength, a device name, a device identifier, a device manufacturer, a device operating system version, a device type, a device version, a geolocation, a measurement public Internet protocol (IP), a wireless network signal strength, a service set identifier (SSID), or a medium access control (MAC) address.

In the method 700, the one or more devices serve as measurement points configured to hold unique session identifiers representing performance measurement sessions between the one or more devices and the one or more delegating agents, and wherein each of the measurement points is associated with a specific session configuration.

In the method 700, the performance measurement data is associated with a predetermined reporting period.

In the method 700, the performance measurement data is generated in a Two-Way Active Measurement Protocol (TWAMP) session between the one or more devices and the reflector.

In the method 700, the performance measurement data is generated by the reflector in response to a plurality of test measurement packets sent by the one or more devices in the TWAMP session.

In the method 700, the one or more devices have limited processing capability such that they cannot manage or process the performance measurement data.

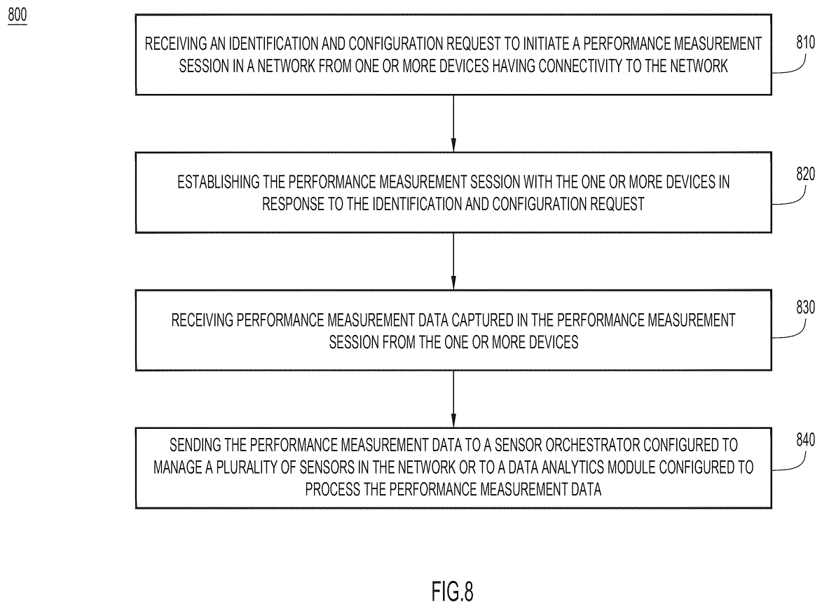

FIG. 8 is a flow diagram illustrating a method for sending network performance measurement data to a sensor orchestrator or to a data analytics module, according to an example embodiment. The method 800 may be implemented by the delegating agents 150a-150n of FIG. 1.

At 810, the method 800 involves one or more delegating agents receiving an identification and configuration request to initiate a performance measurement session in a network from one or more devices having connectivity to the network.

At 820, the method 800 involves the one or more delegating agents establishing the performance measurement session with the one or more devices in response to the identification and configuration request.

At 830, the method 800 involves the one or more delegating agents receiving performance measurement data captured in the performance measurement session from the one or more devices.

At 840, the method 800 involves the one or more delegating agents sending the performance measurement data to a sensor orchestrator configured to manage a plurality of sensors in the network or to a data analytics module configured to process the performance measurement data.

In the method 800, the one or more devices comprise one or more of a mobile phone, a mobile computer, a router, a switch or a modem.

In the method 800, the identification and configuration request comprises one or more performance measurement parameters obtained from the one or more devices.

In the method 800, the one or more performance measurement parameters comprise one or more of a data protocol, a data signal strength, a device name, a device identifier, a device manufacturer, a device operating system version, a device type, a device version, a geolocation, a measurement public Internet protocol (IP), a wireless network signal strength, a service set identifier (SSID), or a media access control (MAC) address.

In the method 800, the one or more devices serve as measurement points configured to hold unique session identifiers representing performance measurement sessions between the one or more devices and the one or more delegating agents, and wherein each of the measurement points is associated with a specific session configuration.

In the method 800, the performance measurement data is associated with a predetermined reporting period.

In the method 800, the performance measurement data is generated in a Two-Way Active Measurement Protocol (TWAMP) session between the one or more devices and a reflector.

In the method 800, the performance measurement data is generated by the reflector in response to a plurality of test measurement packets sent by the one or more devices in the TWAMP session.

In the method 800, the one or more devices have limited processing capability such that they cannot manage or process the performance measurement data.

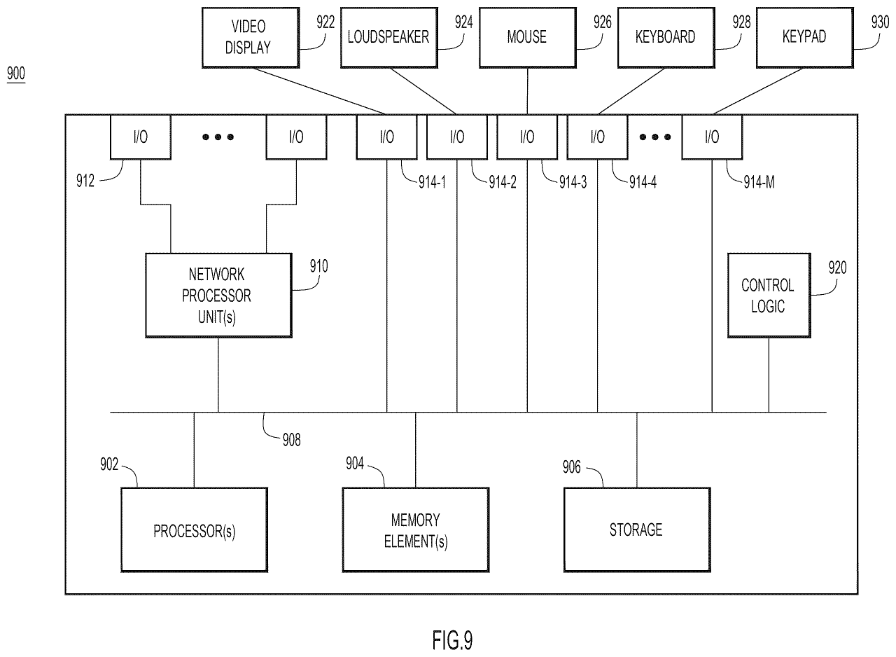

Referring to FIG. 9, FIG. 9 illustrates a hardware block diagram of a computing device 900 that may perform functions associated with operations discussed herein in connection with the techniques depicted in FIGS. 1-8. In various embodiments, a computing device or apparatus, such as computing device 900 or any combination of computing devices 900, may be configured as any entity/entities as discussed for the techniques depicted in connection with FIGS. 1-8 in order to perform operations of the various techniques discussed herein.

In at least one embodiment, the computing device 900 may be any apparatus that may include one or more processor(s) 902, one or more memory element(s) 904, storage 906, a bus 908, one or more network processor unit(s) 910 interconnected with one or more network input/output (I/O) interface(s) 912, one or more I/O interface(s) 914-1, 914-2, 914-3, 914-4, . . . , 914-M, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa), or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 (wired and/or wireless) to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914-1 to 914-M allow for input and output of data and/or information with other entities that may be connected to computing device 900. For example, I/O interface(s) 914-1 to 914-M may provide a connection to external devices such as a video display (e.g., touch-screen display) 922, loudspeaker 924, mouse 926, keyboard 928, keypad 930, and/or any other suitable input and/or output device now known or hereafter developed. It is also envisioned that many of these external devices may be integrated as part of the computing device 900. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4(IPv4 ) and/or IP version 6(IPv6 ) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
sending, by one or more devices having connectivity to a network, an identification and configuration request to one or more delegating agents to initiate a performance measurement session in the network;
receiving, by the one or more devices, session configuration data associated with the performance measurement session from the one or more delegating agents;
configuring, by the one or more devices, the performance measurement session based on the session configuration data;
receiving, by the one or more devices, performance measurement data from a reflector in the network during the performance measurement session; and
distributing, by the one or more devices, the performance measurement data to the one or more delegating agents configured to manage or process the performance measurement data.

2. The method of claim 1, wherein the one or more devices comprise one or more of a mobile phone, a mobile computer, a router, a switch or a modem.

3. The method of claim 1, where the identification and configuration request comprises one or more performance measurement parameters obtained from the one or more devices.

4. The method of claim 3, where the one or more performance measurement parameters comprise one or more of a data protocol, a data signal strength, a device name, a device identifier, a device manufacturer, a device operating system version, a device type, a device version, a geolocation, a measurement public Internet protocol (IP), a wireless network signal strength, a service set identifier (SSID), or a media access control (MAC) address.

5. The method of claim 1, wherein the one or more devices serve as measurement points configured to hold unique session identifiers representing performance measurement sessions between the one or more devices and the one or more delegating agents, and wherein each of the measurement points is associated with a specific session configuration.

6. The method of claim 1, wherein the performance measurement data is associated with a predetermined reporting period.

7. The method of claim 1, wherein the performance measurement data is generated in a Two-Way Active Measurement Protocol (TWAMP) session between the one or more devices and the reflector.

8. The method of claim 7, wherein the performance measurement data is generated by the reflector in response to a plurality of test measurement packets sent by the one or more devices in the TWAMP session.

9. The method of claim 1, wherein the one or more devices have limited processing capability such that they cannot manage or process the performance measurement data.

10. A method comprising:
receiving, by one or more delegating agents, an identification and configuration request to initiate a performance measurement session in a network from one or more devices having connectivity to the network;
establishing, by the one or more delegating agents, the performance measurement session with the one or more devices in response to the identification and configuration request;
receiving, by the one or more delegating agents, performance measurement data captured in the performance measurement session from the one or more devices; and
sending, by the one or more delegating agents, the performance measurement data to a sensor orchestrator configured to manage a plurality of sensors in the network or to a data analytics module configured to process the performance measurement data.

11. The method of claim 10, wherein the one or more devices comprise one or more of a mobile phone, a mobile computer, a router, a switch or a modem.

12. The method of claim 10, where the identification and configuration request comprises one or more performance measurement parameters obtained from the one or more devices.

13. The method of claim 12, where the one or more performance measurement parameters comprise one or more of a data protocol, a data signal strength, a device name, a device identifier, a device manufacturer, a device operating system version, a device type, a device version, a geolocation, a measurement public Internet protocol (IP), a wireless network signal strength, a service set identifier (SSID), or a media access control (MAC) address.

14. The method of claim 10, wherein the one or more devices serve as measurement points configured to hold unique session identifiers representing performance measurement sessions between the one or more devices and the one or more delegating agents, and wherein each of the measurement points is associated with a specific session configuration.

15. The method of claim 10, wherein the performance measurement data is associated with a predetermined reporting period.

16. The method of claim 10, wherein the performance measurement data is generated in a Two-Way Active Measurement Protocol (TWAMP) session between the one or more devices and a reflector.

17. The method of claim 16, wherein the performance measurement data is generated by the reflector in response to a plurality of test measurement packets sent by the one or more devices in the TWAMP session.

18. The method of claim 10, wherein the one or more devices have limited processing capability such that they cannot manage or process the performance measurement data.

19. An apparatus comprising:
a network interface that enables network communications;
a memory; and
one or more processors coupled to the network interface and the memory, wherein the one or more processors are configured to perform operations including:
receiving an identification and configuration request to initiate a performance measurement session in a network from one or more devices having connectivity to the network;
establishing the performance measurement session with the one or more devices in response to the identification and configuration request;
receiving performance measurement data captured in the performance measurement session from the one or more devices; and
sending the performance measurement data to a sensor orchestrator configured to manage a plurality of sensors in the network or to a data analytics module configured to process the performance measurement data.

20. The apparatus of claim 19, wherein the one or more devices have limited processing capability such that they cannot manage or process the performance measurement data.
